(19) United States
(12) Patent Application Publication
(10) Pub. No.: US 2004/0017483 A1
(43) Pub. Date: Jan. 29, 2004

(54) Information recording apparatus with prioritized sound recording and method for operating same

(75) Inventors: Yasuo Kitsugi, Tokyo (JP); Noboru Akami, Tokyo (JP); Hiroshi Wakabayashi, Tokyo (JP)

Correspondence Address: OLIFF & BERRIDGE, PLC, P.O. BOX 19928, ALEXANDRIA, VA, 22320, US

(73) Assignee: Nikon Corporation, Tokyo (JP)

(21) Appl. No.: 10/421,728

(22) Filed: Apr. 24, 2003

Related U.S. Application Data
(63) Continuation of application No. 09/479,928, filed on Jan. 10, 2000, now abandoned.
Application No. 09/479,928 is a continuation of application No. 08/874,338, filed on Jun. 13, 1997, now abandoned.

(30) Foreign Application Priority Data
Jun. 14, 1996 (JP) 8-153781

(51) Int. Cl. H04N 5/225

(52) U.S. Cl. 348/207.99

(57) ABSTRACT

The voltage of batteries is detected, and a determination is made whether the detected voltage is less than the normal value. If the detected voltage is below the normal value, a determination is made whether a sound recording priority flag is on. If the sound recording priority mode has not been set, a low battery level warning sound is generated to indicate that the level of the battery is low. If a determination is made that the sound recording priority mode has been set, however, the battery level warning sound (or other various operating sounds of the camera) is not generated. As a result, noise is reduced because the battery level warning sound and/or other operating sounds are not recorded.

### INCORPORATION BY REFERENCE

The disclosure of the following priority application is herein incorporated by reference: Japanese Patent Application No. Hei-8-153781 filed Jun. 14, 1996.

### BACKGROUND OF THE INVENTION

1. Field of Invention

The present invention relates to an information recording apparatus. In particular, the present invention relates to an information recording apparatus which is operated so that the camera's various operation sounds are not recorded when sound information is recorded onto a recording medium. The invention also relates to a method for operating an information recording apparatus.

2. Description of Related Art

Recently, electronic cameras have been introduced to the public. Even though an image of an object is recorded onto a film when the object is shot with a normal film-type camera, the image data is recorded into an electronic recording medium, such as a memory card, in the electronic cameras. A strobe (flash) is attached to the electronic camera, so that object can be shot as illuminated by emitting the strobe (flash) in a dark environment.

Moreover, in this electronic camera, sound information can be recorded into the memory card for a certain time after shooting the image, accompanying the shooting.

The conventional electronic cameras can not only shoot the object as described above, but also record the sound information. However, it has been a problem that operation noise from emitting the strobe or operation sound for charging the strobe, which is continuously executed for the next emission after the previous emission, for example, are recorded in addition to the sound information originally to be recorded.

### SUMMARY OF THE INVENTION

It is an object of the present invention to provide an information recording apparatus in which the camera's operation sounds are not recorded as noises.

According to one aspect of the invention, the information recording apparatus comprises a recording device for recording at least one of sound information and other information onto a recording medium, a selection device for selecting a first mode for recording the sound information and a second mode for not recording the sound information, a generation device for generating an operation sound, the generation device being operated in relation to the recording of the other information, and a prohibition device for prohibiting generating operation sound by the generation device while the first mode is selected. In this information recording apparatus, sound information and image information, for example, and the like are recorded in a recording medium. The sound information is not recorded at the time of the second mode, but recorded at the time of the first mode. When the first mode is selected to record the sound information, generation of operation sound, such as that associated with the strobe, is prohibited by the prohibition device.

These and other aspects of the present invention will be described in or apparent from the following detailed description of preferred embodiments.

### BRIEF DESCRIPTION OF THE DRAWINGS

Preferred embodiments of the invention will be described in conjunction with the following drawings, in which:

FIG. 1 is a front perspective view showing a structure of an embodiment of the electronic camera to which the present invention is applied;

FIG. 2 is a rear perspective view showing a structure of the electronic camera shown in FIG. 1;

FIG. 3 is a perspective view showing an internal structure of the electronic camera shown in FIG. 1 and FIG. 2;

FIG. 4 is a block diagram showing an internal electric structure of the electric camera shown in FIG. 1 and FIG. 2;

FIG. 5 shows an example of displaying a setup item selection screen;

FIG. 6 is a flow chart explaining a sound recording mode setup processes;

FIG. 7 shows an example of displaying a sound recording setup screen;

FIG. 8 shows an example of displaying a sound recording time setup screen;

FIG. 9 shows an example of displaying a speed light setup screen;

FIG. 10 is a flow chart explaining the operations of the shooting process;

FIG. 11 is a flow chart explaining the details of the exposure calculation processes in steps 26, S39, and S44;

FIG. 12 is a flow chart explaining the sound recording process in the sound recording mode 2;

FIG. 13 is a flow chart explaining the sound recording process in the sound recording mode 3;

FIG. 14 is a flow chart explaining the battery level detection process; and

FIG. 15 is shows an example of displaying the recording status.

### DETAILED DESCRIPTION OF PREFERRED EMBODIMENTS

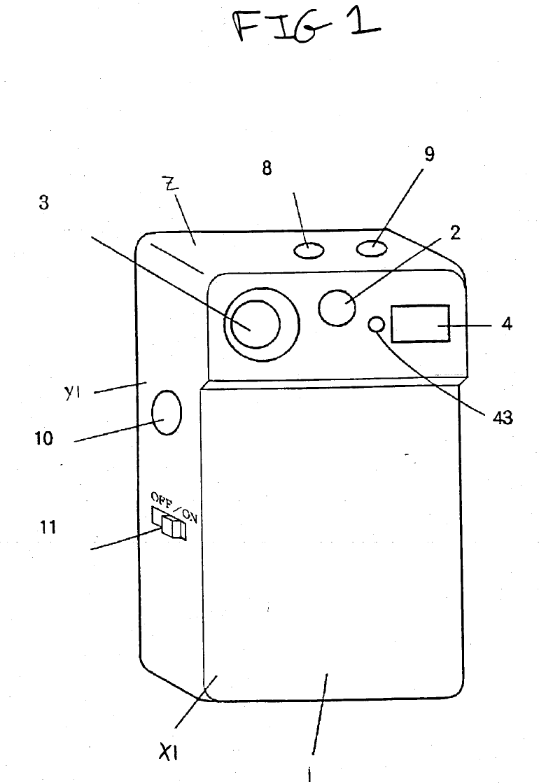

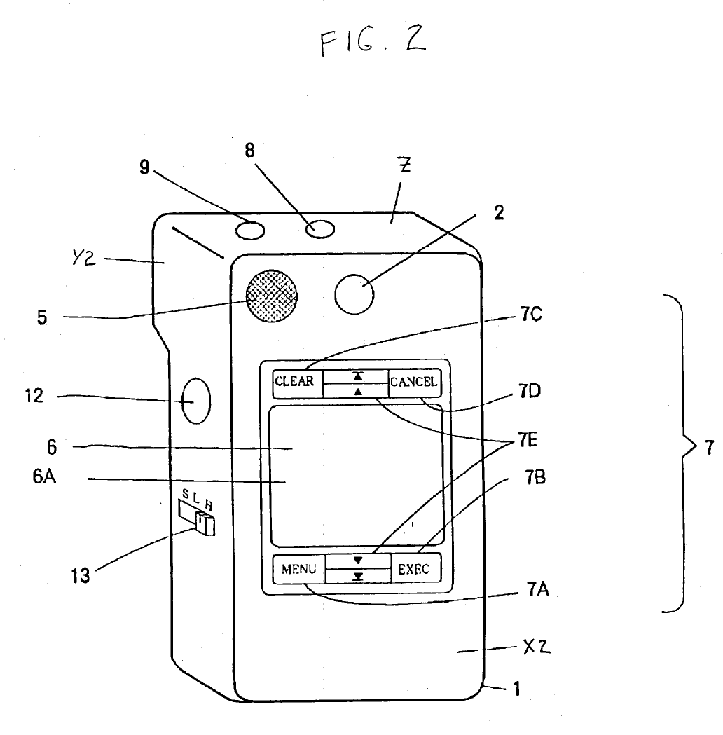

FIG. 1 and FIG. 2 are perspective views showing a structure of an embodiment of an electronic camera applied with the present invention. The electronic camera 1 of the present embodiment includes a side facing the object when shooting the object's designated side X1, and a side facing the user is designated side X2. Provided on the top part of the side X1 are a finder 2 used for confirming the scope of shooting the object, a shooting lens 3 for taking in an optical image of the object, a light emission part (strobe or flash) 4 (generation means) for emitting light to illuminate the object. A red-eye reduction lamp 43 is provided adjacent the light emission part 4.

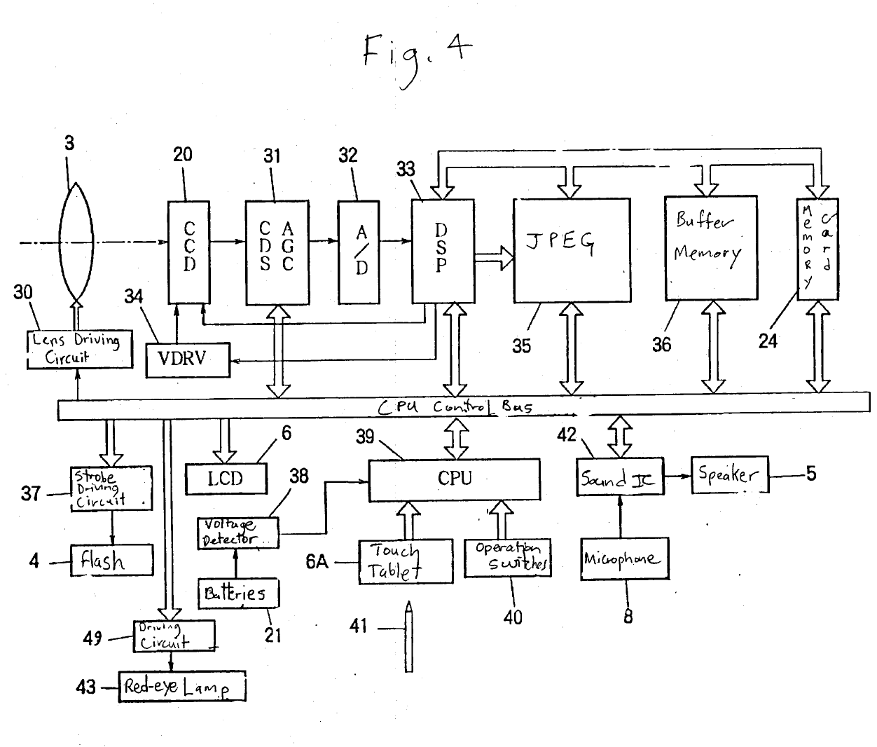

Provided on the top part of the side X2, at a position opposite to the top part of side X1, are the opposite side of the finder 2, and a speaker 5 which outputs sound recorded in the electronic camera 1. An LCD 6 and operation keys 7 are formed vertically below the finder 2, shooting lens 3, light emission part 4, and the speaker 5. On the surface of the LCD 6, a touch tablet 6A is formed which outputs positional data corresponding to a position indicated by contacting the touch tablet 6A with, for example, a pen 41 (FIG. 4), described below.

The touch tablet 6A is composed of a transparent material, such as glass or resin, and the user can view through the touch tablet 6A images that are displayed on the LCD 6 formed inside the touch tablet 6A.

The operation keys 7 are operated when reproducing and displaying recorded data, and the like, which are composed of the following keys. A menu key 7A is a key operated when displaying a menu screen on the LCD 6. An execution key 7B is a key operated when playing the recorded information that has been selected by the user.

A clear key 7C is a key operated when deleting the recorded information. A cancel key 7D is a key operated when terminating (interrupting) the reproduction process of the recorded information. A scroll key 7E is a key operated when scrolling the scroll in upward and downward directions in case a list of recorded information is displayed on the LCD 6.

Provided on side Z, the top side of the electronic camera 1, are a microphone 8 for collecting sounds and an earphone jack 9 to which an earphone (not shown) is connected.

On the left side (side Y1), a release switch 10 that is operated when shooting the object, and a power switch 11 are provided. The release switch 10 and the power switch 11 are arranged vertically below the finder 2, the shooting lens 3, and the light emission part 4.

In contrast, on a side Y2 (right side) on the other side of the side Y1, a sound recording switch 12 which is operated when recording sound, and a continuous shooting mode changing switch 13 which is operated when changing the continuous shooting mode at the time of shooting the object, are provided. The sound recording switch 12 and continuous shooting mode changing switch 13 are arranged vertically below the finder 2, shooting lens 3, and light emission part 4 which are provided on the top part of the side X1, in the same manner as the release switch 10 and power switch 11. Moreover, the recording switch 12 is formed at substantially the same height as that of the release switch 10 on the side Y1 so that the user does not feel awkward even if he/she holds the electronic camera with either his/her right or left hand. However, the height of the release switch 10 and the recording switch 12 can be intentionally made different so that in case one of the switches is pressed by a finger, the other switch would not be accidentally pressed when the opposite side is held by another finger at the same time to cancel out the moment generated by the pressure (created from the finger on the other side).

The continuous shooting mode changing switch 13 is used when setting the number of frames for any particular image to be shot, e.g., for just one frame or for a specified plurality of frames as the user presses the release switch 10. For example, when the continuous shooting mode switch 13 is switched to a position indicated as “S”, only one frame of an image is shot.

In addition, if the release switch 10 is pressed when the continuous shooting mode switch 13 is switched to a position printed as “L”, the shooting is accomplished at a rate of 8 frames per second while the release button is pressed (i.e., shooting in a low-speed continuous shooting mode).

Moreover, if the release switch 10 is pressed when the position of the continuous shooting mode switch 13 is switched to a position printed as “H”, the shooting is accomplished at a rate of 30 frames per second while the release button is being pressed (i.e., shooting in a high-speed continuous shooting mode).

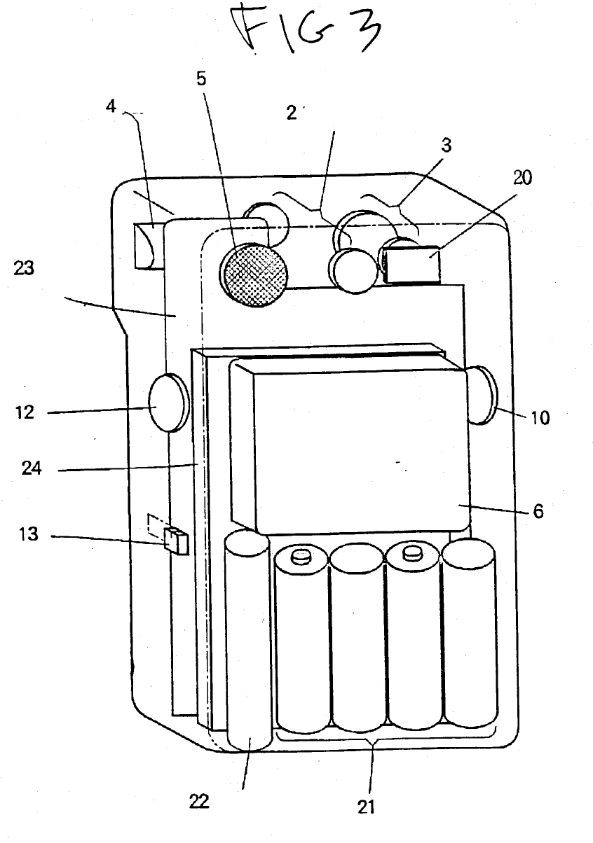

Next, the internal structure of the electronic camera 1 is described. FIG. 3 is a perspective view showing an example of internal structure of the electronic camera shown in FIG. 1 and FIG. 2. A CCD 20 is provided on the rear part (on the side X2) of the shooting lens 3 and constructed to photoelectrically convert the optical image of the object formed through the shooting lens into electronic signals.

Vertically (perpendicularly) below the LCD 6, four cylinder-shaped batteries 21 (e.g., AA dry cells), are vertically arranged and supply power to each component of the camera indirectly or directly connected to the batteries. Also, a condenser 22 that accumulates electric charges for powering the light emission part 4 is arranged alongside the battery 21.

Various control circuits that control each part of the electronic camera 1 are formed on a circuit board 23. In addition, between the circuit board 23, LEC 6 and batteries 21, a memory card 24 that can be inserted or ejected is provided, and various information input to the electronic camera 1 is recorded in each preset area of the memory card 24.

In addition, in the present embodiment, the memory card 24 is made insertable and ejectable. However, a memory can be provided on the circuit board 23, and various kinds of information can be recorded in the memory. In addition, it is also possible to output the various information recorded in the memory (or memory card 24) to an external personal computer or the like through an interface that is not shown in the figure.

Next, an electrical structure inside of the electronic camera of the present embodiment is described with reference to a block diagram shown in FIG. 4. The CCD 20, which includes a plurality of pixels, photoelectrically converts an optical image formed on each pixel into image signals (electric signals). A CCD driving circuit (VDRV) 34 is controlled by a digital signal processor (DSP) 33 to drive the CCD 20.

The driving circuit 30 drives the shooting lens 3 in the direction of the optical axis to control a focusing state. A correlated double sampling circuit (referred as CDS hereafter) and an AGC circuit 31 sample the image signals photoelectrically converted by the CCD 20 at predetermined timing, and control the image signals so that the level thereof becomes a specified value. An analog/digital conversion circuit 32 is composed to digitize and supply the image signals sampled at the CDS circuit and AGC circuit 31, to the DSP 33.

The DSP 33 processes gamma correction to the input image data of R, G and B and determines brightness data or color difference data by calculations. The data output from the DSP 33 is temporarily stored in a buffer memory 36. A compression/decompression circuit and memory controller 35 (recording means) compress the image data recorded in the buffer memory 36 in the JPEG method, and transfers the data to the memory card 24 for storage. In addition, the compression/decompression circuit and memory controller 35 also read the image data stored in the memory card to perform decompression processes.

The strobe driving circuit 37 (charging means) including the condenser 22 drives the strobe (flash) 4 (light emitting means) to generate a flash. The red-eye reduction lamp 43 is driven by the driving circuit 49.

The image data that has been read from the memory card 24 and stored in the buffer memory 36 is further transferred, and a specified image is displayed on the LCD 6.

The voltage of the batteries which supplies required power to each part is detected by a detecting circuit 38, and the detection results are supplied to the CPU 39. The CPU 39 controls operations of each component, operation signals are input from the operation switches 40 that consist of or comprise various types of switches, such as operation keys 7, release switch 10, power switch 11, and continuous shooting mode changing switch 13, and coordinate data is supplied when touch tablet 6A is operated by the pen 41.

The sound IC 42 converts the sound signal input from the microphone 8 using the A/D converter, compresses the converted signals by the ADPC method, and stores the compressed data into the memory card. In addition, the sound IC 42 is constructed to decompress the sound data read from the memory card 24 and output it through the speaker 5.

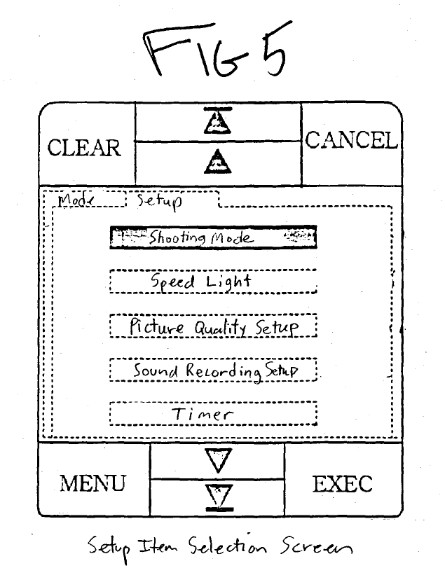

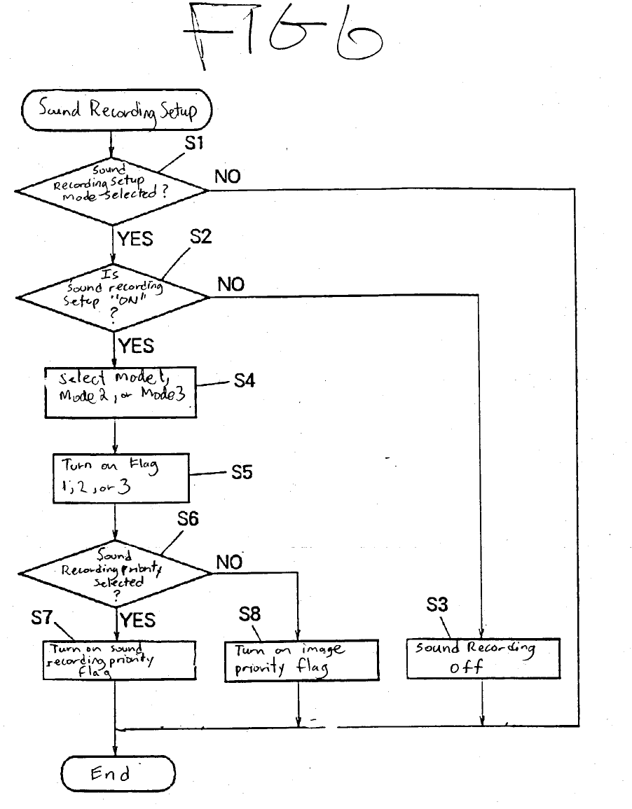

Next, operations of this embodiment are described. When the user operates the touch tablet 6A with the pen 41 prior to shooting the object, to instruct the input of setup items, the CPU 39 displays the setup item selection screen as shown in FIG. 5 on the LCD 6. Inputting various types of setup items is performed from this screen. Setup operations of the sound recording mode are described with reference to the flow chart shown in FIG. 6.

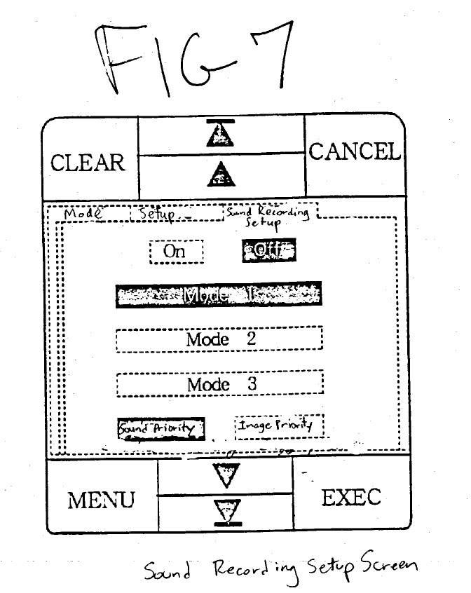

The user selects “sound recording setup” in the display screen shown in FIG. 5 when selecting the sound recording setup mode. In step S1, the CPU 39 determines whether the selection of the sound recording setup mode has been instructed. If the determination has been made that the sound recording setup mode has not been selected, the sound recording mode setup process is completed. In step S1, if the determination is made that the selection of the sound setup mode has been instructed, the CPU 39 displays a sound recording setup screen as shown in FIG. 7, for example, on the LCD 6.

In step S2, a determination is made as to whether the sound recording setup has been turned on in the sound recording setup screen. The user selects an indication “Off” in the sound recording setup screen shown in FIG. 7 when turning off the sound recording mode. At this time, the CPU executes a process to turn off the sound recording mode as the process moves to step S3.

On the other hand, when setting the sound recording mode, the user operates with the pen 41 an indication “On” in the sound recording setup screen shown in FIG. 7. At this time, the process further moves to step S4, in which the user makes an instruction by selecting with the pen 41 “Mode 1,” “Mode 2” or “Mode 3” shown in FIG. 7, for selecting either sound recording mode 1, 2 or 3. Mode 1 is a mode for recording sound for a specified time that has set in advance. Mode 2 is a mode for recording sound while the sound recording switch 12 is being operated independently from the operation of the release switch 10. Mode 3 is a mode for starting recording sound when the sound recording switch 12 is pressed once and stops recording sound when the recording switch 12 is operated one more time, independently from the operation of the release switch 10.

If any mode has been selected among these three modes, the CPU 39 in step S5 turns on a flag of the sound recording mode selected in step S4. In other words, a flag of either the sound recording mode 1, 2 or 3 is turned on.

Then, the user instructs whether the sound recording priority mode or the image priority mode is setup, following the selection of the mode. In the sound recording priority mode, even though there are cases in which the quality of the images to be shot may be sacrificed, the sound is recorded so that the operation sound of the electronic camera 1 is not included in the sound information. In contrast, in the image priority mode, despite the fact that the operation sound of the electronic camera 1 may be included in the sound information, clearer images can be recorded. The user can select either the sound recording priority mode or the image priority mode by selecting either indication “sound priority” or “image priority” shown in FIG. 7.

The CPU 39 determines in step S6 whether the sound recording priority mode has been selected, and if the determination is made that the sound recording priority mode has been selected, the process moves to step S7 to turn on the sound recording priority flag. On the other hand, if the determination is made in step S6 that the sound recording priority mode has not been selected (determined that the image priority mode has been selected), the process moves to step S8 to turn off the image priority flag. The sound recording priority flag and image priority flag are flags which are chosen between two alternatives. In other words, the image priority flag is turned off when the sound recording flag is turned on, and the sound recording priority flag is turned off when the image priority flag is turned on.

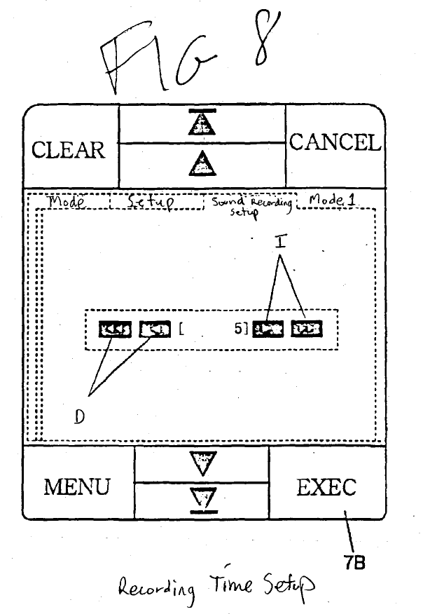

Furthermore, when the user selects the sound recording mode 1 in step S4 shown in FIG. 5, the CPU 39 displays the recording time setup screen as shown in FIG. 8 on the LCD 6. In an example of the display shown in FIG. 8, a number 5 (5 seconds) is displayed as the recording time. Then, the user can increment or decrement this number by operating an increment key I and a decrement key displayed on the right and left side of this number 5. When the increment key or the decrement key D indicated with one triangle is operated, the number is increased (incremented) or decreased by one. On the other hand, when the increment key I or the decrement key D indicated with two triangles is operated, the number is increased or decreased by five. When inputting the number is completed, the user operates the execution key 7B. When the execution key 7B is operated, the CPU 29 reads the number being displayed on the LCD 6 as the recording time for the recording mode 1 and stores it to the memory card 24.

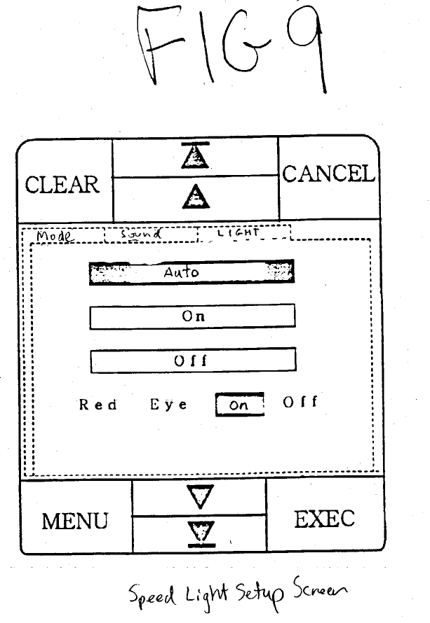

In the display screen shown in FIG. 5, when the indication “speed light” is selected, the CPU 39 displays a speed light setup screen as shown in FIG. 9 on the LCD 6. The user then selects “Auto” when automatically judging whether strobe emits or not based on the calculation of exposure, “On” when forcefully using the strobe 4, or “Off” when prohibiting the usage of the strobe 4. A flag turns on in response to this selection.

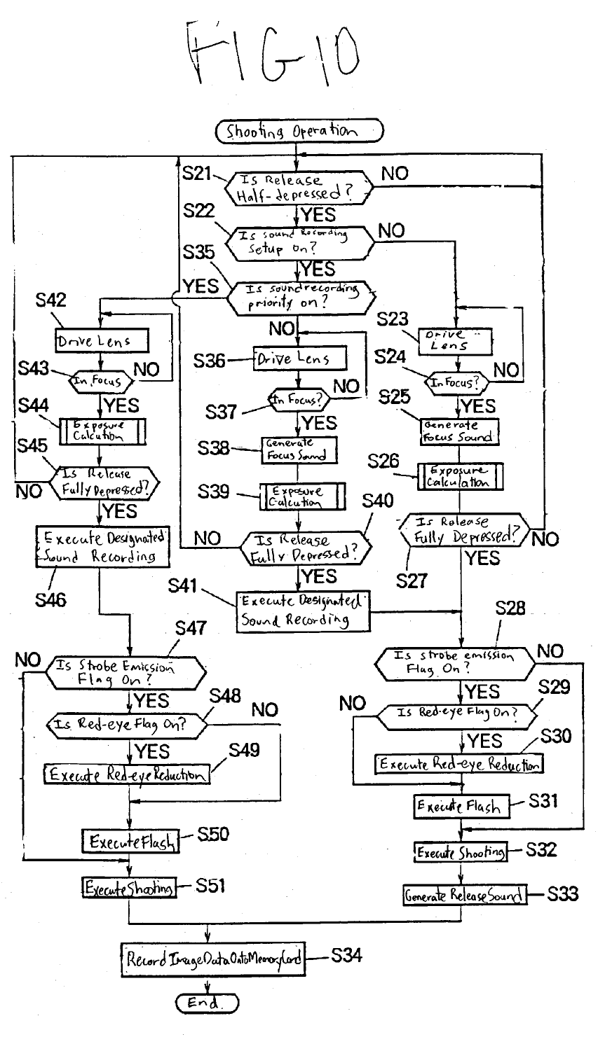

Next, the operations for shooting the object are explained with reference to a flow chart shown in FIG. 10. First, in step S21, the CPU 39 waits until the release switch 10 is in a half-depression state. When the determination is made that the release switch 10 is in the half-depression state, the process moves to step S22 to determine whether the sound recording setup has been turned on, that is, if one of the flags for the sound recording mode 1, 2 and 3 has been turned on.

When none of the flags has been turned on, the process moves to step S23, in which the CPU 39 controls the driving circuit 30 to move the shooting lens 3 in the direction of the optical axis. At this time, the DPS 33 controls the CCD driving circuit 34 to read the image of the object formed on the CCD 20.

The signals output from the CCD 20 are sampled at the CDS circuit and AGC circuit 31, converted in analog/digital at the A/D conversion circuit 32 after being controlled to signals at a specified level, and supplied to the DSP 33. Then DSP 33 determines from the input image data as to whether focusing has been made, i.e., whether focusing has been made from the input image data. The focusing operation continues until the DSP 33 determines that the focusing has been made. When a determination is made that focusing has been made, the DSP 33 notifies the focusing to the CPU 39. Then, when the CPU 39 receives this notification in step S24, the CPU 39 controls the sound IC 42 in step S25 to generate the focusing sound, which is output from the speaker 5. As a result of this focusing sound, the user is informed of the focusing.

An exposure calculation process is performed in step S26. After the exposure calculation process has been performed, the process moves to step S27 to determine whether the release switch 10 is a full-depression state. When the determination is made that the release switch 10 has not become the full-depression state, the process returns to step 21 and repeats to execute step 21.

In other words, while the release switch 10 is in the half-depression state, the focusing operations and the exposure calculation process are repeatedly executed. The focusing sound is generated at the time of focusing the object if the sound recording setup (S22) is not on, or if the image priority mode has been set up (i.e., the sound recording priority (S35) is not on).

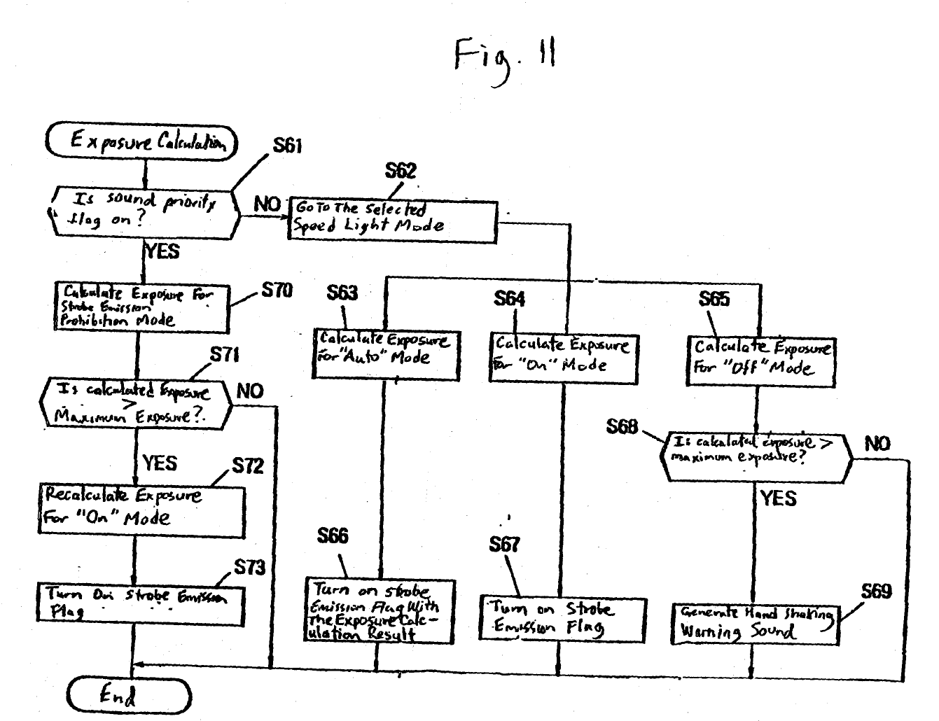

Next, details of the exposure calculation process in step S26 are described with reference to a flow chart shown in FIG. 11. First, the CPU 39 determines in step S61 whether the sound recording priority flag has been turned on. If the sound priority flag has not been turned on (when the image priority flag has been turned on) the process moves to step S62 to execute in the DSP 33 the calculation of exposure at the exposure mode that has been set up (“Auto,” “On” or “Off” in FIG. 9).

If “Auto” is selected in FIG. 9, the DSP 33 automatically calculates the exposure time in step S63, and the strobe emits light as needed. Then, the process moves to step S66 to turn on the strobe emission flag when the determination is made that the strobe has to be emitted as a result of the calculation of exposure.

On the other hand, when the forceful strobe emission mode (“On” in FIG. 9) has been set, the DSP 33 (automatically) performs the calculation of exposure time with a condition to emit the strobe in step S64. Then the process moves to step S67 to turn on the flag.

Furthermore, when the strobe emission prohibition mode (“Off” in FIG. 9) has been set up, the process moves to step S65, and the DSP 33 (automatically) performs the calculation of exposure time with a condition not to emit the strobe. Then, in this case, the process moves to step S68 to determine whether the shutter time (exposure time) obtained as a result of the calculation in step S65 is longer than the longest possible period of exposure time (a specified standard time that has been set up in advance). For instance, if the longest period of time is 1/15 second, a determination is made as to whether the shutter time obtained as a result of the calculation in step S65 is longer than 1/15 second. If the shutter time determined in step S65 is longer than the longest period of time, the process moves to step S69, and a process for generating a hand shaking warning sound is executed. In other words, the CPU 39 controls the sound IC 42 at this time to generate the hand shaking warning sound from the speaker 5. The user is thus warned that blurred images can be created if the user is not careful of shaking hands because the shutter time is long.

When the determination is made in step S68 that the shutter time is shorter than the longest period of time, the image is not blurred even if the hand shaking does in fact occur because shooting the object is completed in sufficiently short time. Then, in this case, the process of step S69 is skipped.

When the determination is made in step S61 that the sound recording priority flag has been turned on, the process moves to step S70, in which the DSP 33 performs the calculation of exposure time in the strobe emission prohibition mode. Then in step S71, the determination is made as to whether the shutter time determined in step S70 is longer than the longest period of time. If the determination is made that the shutter time is longer than the longest period of time, the process moves to step S72 to recalculate the exposure time in the manual or forceful strobe emission mode. Then the process moves to step S73 to turn on the strobe emission flag. In other words, in the current case, even though the setup is made at the sound recording priority mode, it is difficult to shoot images that can be utilized if the shooting is performed without emitting the strobe 4, since the actual shutter time is longer than the maximum shutter time. Then in this case, it is possible that the emission sound of the strobe 4 and the operation sound accompanying the charging of the strobe can be recorded as noises. However, sound recording is less meaningful or takes less priority in a situation involving photographing images that would be too dark to show up without proper exposure. Therefore, the procedure effectively cancels the sound recording priority mode, so that images that can be utilized are obtained. However, since the setup is currently at the sound recording priority mode, the hand shaking warning sound is not generated.

In contrast, when the determination has been made in step S71 that the shutter time determined by the calculation in step S70 is shorter than the longest period of time, the processes in steps S72 and S73 are skipped because there is not necessary to emit the strobe 4. That is, in this case, the hand shaking warning sound, and other operation sound at the time of emitting the strobe or changing the strobe thereafter, are prevented from being recorded as noises.

Returning to the explanations of the flow chart shown in FIG. 10, when the determination is made in step S27 that the release switch is in the full-depression state, the process moves to step S28 to determine whether the strobe emission flag is on. If the strobe emission flag is on, the process moves to step S29 to determine whether the red-eye reduction flag is on. If the determination is made that this flag is on, the process moves to step S30 to execute the process for emitting the red-eye reduction lamp 43. In other words, at this time, the CPU 39 controls the driving circuit 42 to emit the red-eye reduction lamp 43. Then, in step S31, the strobe 4 is driven though the strobe driving circuit 37. As a result, the strobe is emitted, and a flash is illuminated to the object. However, if the determination is made in step S29 that the red-eye reduction flag has not been turned on, the red-eye reduction lamp 43 does not light up. Moreover, if the determination is made in step S28 that the strobe emission flag is off, neither the red-eye reduction lamp 43 nor the strobe 4 is driven.

In step S32, the shooting operations are executed. That is, the DSP 33 controls the CCD driving circuit 34 to drive the CCD 20 to take in the image signals of the object. Further, the process moves to step S33, in which the CPU 39 controls the sound IC 42 to generate a simulated release sound which is output from the speaker 5.

The electronic camera 1 does not control the exposure time by blocking or passing the light entering to the CCD 20 with a physical shutter, which is different from the film-type camera, but the shutter functions are realized by controlling the time to accumulate the electric charges (load) in the CCD 20. Actually, even if the release switch 10 is operated, an operation sound is not generated. However, because the user cannot know that shooting has been performed, if the user does not hear the shutter operation sound, such as that for the film-type camera, even if the release switch 10 is operated, the simulated release sound is intentionally generated to let the user know that the shooting has been performed.

After such shooting has been performed, the process moves to step S34 to execute a process for recording the image data of the object to the memory card 24. In other words, the DSP 33 reads out the electric charge (load) corresponding to the image accumulated (stored) in the CCD 20, through the CCD driving circuit 34, and takes in the image data through the CDS circuit, the AGS circuit 31, and the A/D conversion circuit 32. The DSP 33 calculates the brightness data and the color difference data as well as applying the gamma correction to this image data. Then, the DSP 33 transfers the image data to and stores it in the buffer memory 36. The compression/decompression circuit and memory controller 35 compress the image data with the JPEG method and transfer the compressed data to and stores it in the memory card 24.

In step S22, if the determination is made that the sound recording setup is on, the process moves to step S35 to determines whether the sound recording priority mode has been set up. If the determination is made that the sound recording priority mode has not been set up (when the image priority mode has been set up), the processes in steps S36 through S40 are executed. These processes are substantially the same as the processes in steps S23 through S27, in which the focusing operation and the exposure calculation processes are performed, and the focusing sound is generated when focused, in the same manner as described above.

If the determination is made in step S40 that the release switch 10 is in the full-depression state (when the user executes the shooting operations), the process moves to step S41 to start the operation for recording sound input from the microphone 8 if the flag for the sound recording mode 1 is on., That is, the sound signals input from the microphone 8 are input to the sound IC 42, compressed with the ADPCM method after being converted in A/D, and stored to the memory card 24. These operations are continued until a set time has passed, as explained in reference to the sound recording time setup screen shown in FIG. 8.

As described above, when the sound recording mode 1 has been set up, if the shooting is performed operating the release switch 10, the sound signals are automatically recorded for certain time, accompanying the shooting.

The processes in steps S28 through S34 are executed thereafter. In other words, the strobe 4 and the red-eye reduction lamp 43 are properly lighted up to shoot the images, and the simulated release sound is also generated as well.

On the other hand, if the determination is made in step S35 that the sound recording priority mode has been set, the processes in steps S42 through S45 are executed. These steps are basically the same as the processes in steps S23 through S27; however, the focusing sound is not generated (the step corresponding to step S25 has been eliminated).

In addition, if the determination is made in step S45 that the release switch 10 is in the full-depression state, the process moves to step S46 to record the sound signals for certain time if the sound recording mode 1 has been set up.

Next, the process moves to step S47 to determine whether the strobe emitting flag is on. Then in step S48, a determination is made as to whether the red-eye reduction flag is on. If both the strobe emitting flag and the red-eye reduction flag are on, light emission processes for the red-eye reduction lamp 43 and the strobe 4 are performed in steps S49 and S50. That is, as described above, the strobe 4 (thus the red-eye reduction lamp 43) is set not to emit light in the sound recording priority mode. However, in the processes in steps S71 through S73 shown in FIG. 11, the strobe emission flag has been turned on if the shutter time becomes longer than the longest time if the strobe is not emitted. Thus, the strobe 4 is emitted in this case (therefore, the red-eye reduction lamp 43 is also emitted if the flag is on). Of course, the emission is prohibited when neither the strobe emission flag nor the red-eye reduction flag is on.

Next, the shooting operation is performed in step S51. However, in this case, since the sound recording priority mode has been set, the simulated release sound is not generated. Then, the process moves to step S34 to execute the process to store the image data into the memory card 24.

After accomplishing such shooting processes, if the strobe has been emitted, the CPU 39 to control the strobe driving circuit 37 and charges the condenser 22 for preparing for the next strobe emission.

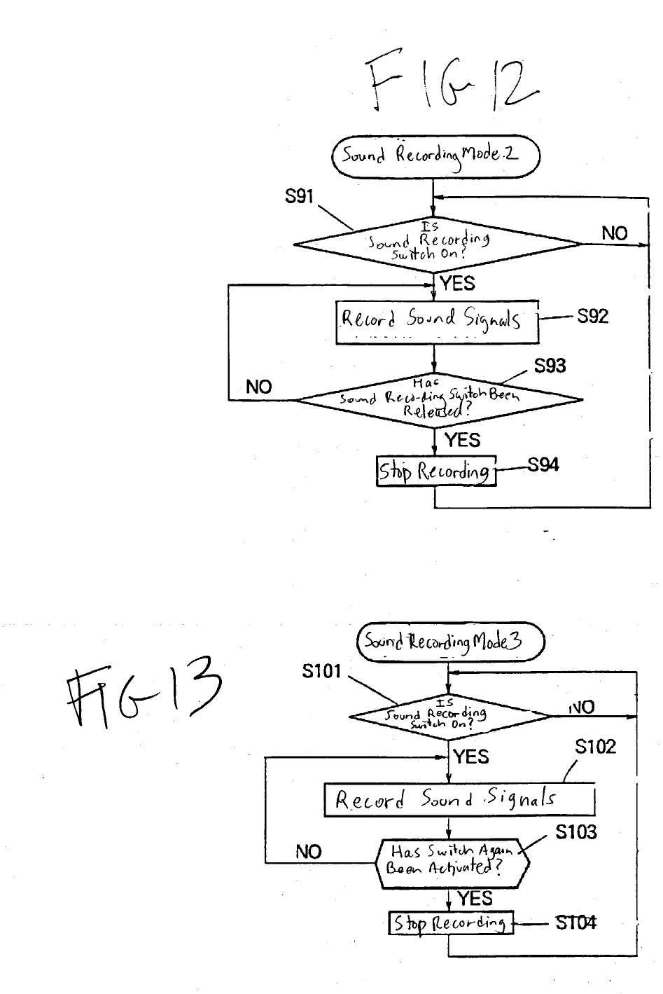

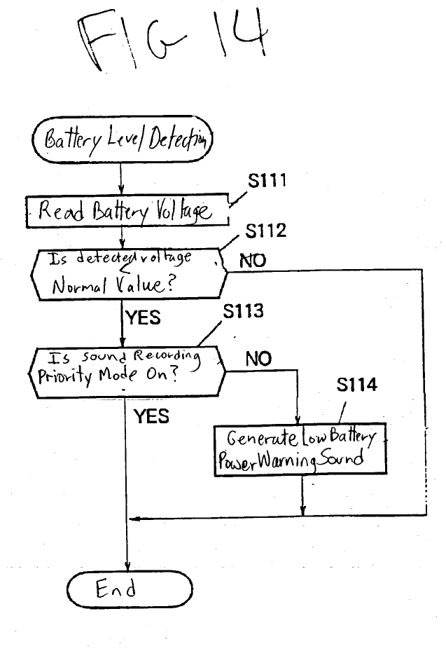

Next, the operations for recording sound in the sound recording modes 2 and 3 are explained with reference to flow charts shown in FIGS. 12 and 13.

When the sound recording mode 2 has been set, the process in step S91 waits until the sound recording switch 12 has been turned on, and when the determination is made that the sound recording switch 12 has been turned on, the process moves to step S92 to execute the process for recording to the memory card 24 the sound signals input from the microphone 8. This process is continued until the determination is made that the sound recording switch 12 has been turned off. Then, in step S93, if the determination is made that the operation of the sound switch 12 has been released, the process moves to step S94 to stop the recording operation. Thereafter, the process returns to step S91 and waits until the sound recording switch 12 is operated again.

In case when the sound recording mode 2 is set up in such manner, the sound can be recorded for a selected predetermined time, independently from the operation of the release switch 10.

On the other hand, when the sound recording mode 3 has set up, processes shown in the flow chart in FIG. 13 are executed. In this case, the process waits in step S101 until the sound recording switch 12 is turned on. When the determination is made that the sound recording switch 12 has been activated, the process moves to step 102. Then, the process for recording to the memory card 24 the sound signal input from the microphone 8 is continued until the determination is made in step S103 that the sound recording switch 12 has again been activated. When the determination is made in step S103 that the sound recording switch 12 has been again activated, the process moves to step S104 to end the recording operations. Thereafter, the process returns to step 101 to repeatedly execute the subsequent processes.

In other words, in the case of sound recording mode 2 shown in FIG. 12, it is necessary that the sound recording switch be continuously depressed while the sound signals are being recorded. On the other hand, in the case of sound recording mode 3 shown in FIG. 13, the recording operation is executed when the sound recording switch 12 is first depressed, even if the sound recording switch 12 is not continuously depressed. Then, when stopping the recording operation, the sound recording switch is activated one more time. Therefore, when recording sound for a relatively long time, the operativity becomes better if the sound recording mode 3 is selected.

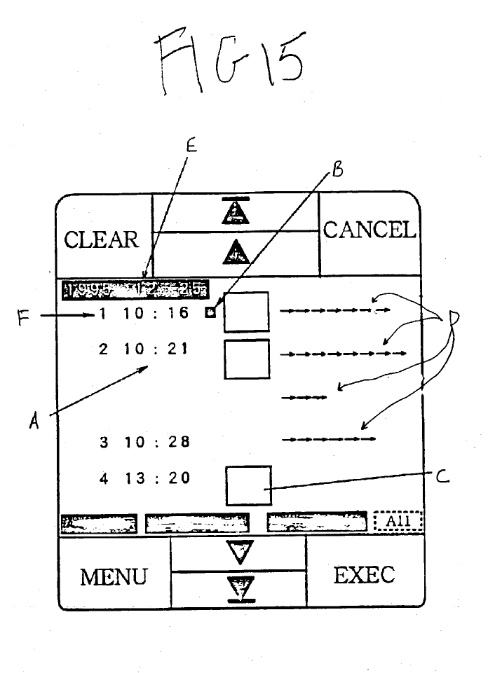

Furthermore, the CPU 39 executes an interrupt process for detecting the remaining power level of the battery, as shown in a flow chart in FIG. 14. In step S111, the CPU 39 reads the voltage of the batteries 21 from the output of the detection from the detection circuit 38. Then, in step S112, the voltage detected in step S111 and a prescribed normal value that is set in advance are compared to determine if the detected voltage is less than the normal value. If the determination is made that the detected voltage is less than the normal value, the process moves to step S113 to determine whether the sound recording priority flag is on. If the determination is made that the sound recording priority flag is not on (the image priority mode has been set up), the process moves to step S114 to generate a warning sound indicated low battery power. That is, the CPU 39 controls the sound IC 42 to generate the low battery power warning sound that indicates the fact the level of the battery remaining is low and outputs the sound from the speaker 5. By doing so, the user can be informed of the time to change the batteries.

On the other hand, if the determination is made in step S113 that the sound recording priority mode has been set, the process in step S114 is skipped. That is, in the sound recording priority mode, the warning sound is not generated even if the level of the battery power is low. As a result, the low battery power warning sound is not recorded to the memory card 24.

If the determination is made in step S112 that the detected voltage is greater than the normal value, the battery power detection process is completed.

In the illustrated embodiment, the camera controller can be implemented as a single special purpose integrated circuit (e.g., ASIC) having a main or central processor section for overall, system-level control, and separate sections dedicated to performing various different specific computations, functions and other processes under control of the central processor section. It will be appreciated by those skilled in the art that the controller can also be implemented using a plurality of separate dedicated or programmable integrated or other electronic circuits or devices (e.g., hardwired electronic or logic circuits such as discrete element circuits, or programmable logic devices such as PLDs, PLAs, PALs or the like). The controller can also be implemented using a suitably programmed general purpose computer, e.g., a microprocessor, microcontroller or other processor device (CPU or MPU), either alone or in conjunction with one or more peripheral (e.g., integrated circuit) data and signal processing devices. In general, any device or assembly of devices on which a finite state machine capable of implementing the flowcharts shown in FIGS. 6 and 10-14 can be used as the controller. As shown, a distributed processing architecture is preferred for maximum data/signal processing capability and speed.

As described above, in the present embodiment, besides recording the image data and sound data to the memory card 24, memo information that is handwritten can also be recorded to the memory card 24. When recording this memo information, the user operates the touch tablet 6A with the pen 41. At this time, coordinate data on the touch tablet 6A is input to the CPU 39, and the CPU 39 transfers to and stores in the memory card 24 the positional coordinate data as the line-drawing information (memo information).

As described, if an instruction is made to the CPU 39 to display the data recorded in the memory card 24 in a state in which the image data, sound data and line-drawing data (memo data) has been recorded in the memory card, the CPU 39 displays the image shown in FIG. 15, for example. In other words, the CPU 39 has a built-in timer, and when the shooting operation, sound recording operation, or memo inputting operation is performed, the CPU 39 records the date and time when the input was performed, into the memory card 24 with the respective data. Each entry is given a control number F. Then, when displaying the recording status of the data stored in the memory card 24 is instructed, the recording date E and recording time A of each data are read and displayed. When a memo has been recorded, a memo mark B indicating that a memo has been recorded, is displayed on the right side of the time. In addition, on the right side of the memo information existing indication marks, thumbnail images C are displayed. The thumbnails C are images in which one image has been reduced to ⅛ the size of the original. The user can confirm then the shot and recorded images from the thumbnail images.

On the right side of the thumbnail images, arrow marks D are displayed when sound information has been recorded. One arrow mark corresponds to, for example, 10 seconds, and recording time of 90 seconds (1 minute and 30 seconds) can be displayed in 1 line. The CPU 39 displays a number of arrows corresponding to the length of the sound data (length at the time of outputting the sound) that has actually been recorded. For instance, when one arrow is displayed, the sound data thereof is within 10 seconds, and when there are two arrow marks displayed, the length of the sound is between 10 to 20 seconds.

The present invention has been described above in a case when the present invention is applied to an electronic camera. However, the present invention can be applied to information recording apparatuses other than the electronic camera. Various modifications of the invention can be made without departing from the spirit and scope of the invention as defined in the appended claims.

What is claimed is:

1. An information recording apparatus, comprising:
recording means for recording into a recording medium at least one of sound information and other information;
selection means for selecting between a first mode for recording said sound information and a second mode for not recording said sound information;
generation means for generating an operation sound operated in relation to the recording operation of said other information; and
prohibition means for prohibiting generation of the operation sound by said generation means while said first mode is selected.

2. The information recording apparatus described in claim 1, wherein said other information is image information and said generating means comprises:
light emitting means for emitting light when shooting the object; and
charging means for electrically charging said light emitting means.

3. The information recording apparatus described in claim 2, further comprising calculation means for calculating an exposure when shooting said object,
wherein said selection means further enables selection between an image priority mode for prioritizing recording of said image information and a sound recording priority mode for prioritizing recording of said sound information, and
wherein said calculation means calculates the exposure for a state in which flash is prohibited by the light emitting means when said sound recording priority mode is selected.

4. The information recording apparatus described in claim 3, wherein, during said sound recording priority mode, if an exposure time is calculated that is longer than a preset standard value, said calculating means further calculates the exposure in a state in which said light emitting means emits light, and flash of the light emitting means is not prohibited.

5. The information recording apparatus described in claim 1, wherein the operation sound includes at least one of a sound for indicating focusing of an object, a simulated shutter sound generated when shooting an object, and a warning sound for warning of vibration of a camera due to vibrations of a user's hand when shooting an object.

6. An information recording apparatus, comprising:
a recording component that records into a recording medium at least one of sound information and other information;
a selection component, coupled to the recording component, that enables selection between a first mode for recording said sound information and a second mode for not recording said sound information;
a generation component, coupled to the selection component, that generates an operation sound operated in relation to the recording operation of said other information; and
a prohibition component, coupled to the generation component, that prohibits generation of the operation sound by said generation component while said first mode is selected.

7. The information recording apparatus described in claim 6, wherein said other information is image information and said generating component comprises:
a light emitting component for emitting light when shooting the object; and
a charging component for electrically charging said light emitting component.

8. The information recording apparatus described in claim 7, further comprising:
a calculation component for calculating exposure when shooting said object,
wherein said selection component further enables selection between an image priority mode for prioritizing recording of said image information and a sound recording priority mode for prioritizing recording of said sound information, and
wherein said calculation component calculates the exposure for a state in which flash is prohibited by said light emitting component when said sound recording priority mode is selected.

9. The information recording apparatus described in claim 8, wherein, during the sound recording priority mode, if an exposure time is calculated that is longer than a preset standard value, said calculating component further calculates the exposure in a state in which said light emitting component emits light, and flash by said light emitting component is not prohibited.

10. The information recording apparatus described in claim 6, wherein the operation sound includes at least one of a reporting sound for indicating focusing of an object, a simulated shutter sound generated when shooting an object, and a warning sound for warning of vibration of a camera due to vibrations of a user's hand when shooting an object.

11. A method of operating an information recording apparatus, comprising:
recording at least one of sound information and other information;
selecting between as least a first mode for recording said sound information and a second mode for not recording said sound information;
generating an operation sound operated in relation to the recording operation of said other information; and
prohibiting generation of the operation sound while said first mode is selected.

12. The method described in claim 11, wherein said other information is image information, and the method further includes:
providing light emitting component for emitting light when shooting a object; and
electrically charging said light emitting component.

13. The method described in claim 12, further comprising:
calculating exposure when shooting the object;
selecting between an image priority mode for prioritizing recording of said image information and a sound recording priority mode for prioritizing recording of said sound information; and
calculating the exposure for a state in which flash of the light emitting component is prohibited when the sound recording priority mode is selected.

14. The method described in claim 13, wherein, when an exposure time is calculated that is longer than a preset standard value during the sound recording priority mode, further calculating the exposure in a state in which said light emitting component emits light, and flash by the light emitting component is not prohibited.

15. The method described in claim 11, wherein the generating includes at least one of reporting sound for indicating focusing of an object, generating a simulated shutter sound when shooting an object, generating a warning sound for warning of vibration of a camera due to vibrations of a user's hand when shooting an object, and generating a warning sound for warning low battery level of a camera.
